(19) United States
(12) Patent Application Publication
(10) Pub. No.: US 2026/0332343 A1
(43) Pub. Date: Oct. 22, 2026

(54) SYNCHRONIZATION SIGNAL PHASE ROTATION FOR TIME-VARIANT INFORMATION INDICATION

(71) Applicant: Lenovo (United States) Inc., Morrisville, NC (US)

(72) Inventors: Karthikeyan Ganesan, Nauheim (DE); Seyedomid Taghizadeh Motlagh, Oberursel (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/573,871

(22) Filed: Mar. 20, 2026

(51) Int. Cl. H04L 5/00; H04W 48/08

(52) U.S. Cl. CPC H04L 5/0051; H04W 48/08

(57) ABSTRACT

Various aspects of the present disclosure relate to synchronization signal phase rotation for time-variant information indication. An apparatus, such as a user equipment (UE), receives a first synchronization signal associated with a first synchronization signal block (SSB), where the first synchronization signal is associated with a first phase. The UE receives a second synchronization signal associated with the first SSB or a second SSB, where the second synchronization signal is associated with a second phase that is rotated relative to the first phase The UE communicates in accordance with time-variant information, where the time-variant information is based on one or more of a phase rotation calculated using the first phase and the second phase or mapping information associated with the time-variant information.

### TECHNICAL FIELD

The present disclosure relates to wireless communications, and more specifically to synchronization signal phase rotation for time-variant information indication.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a first synchronization signal associated with a first synchronization signal block (SSB), where the first synchronization signal is associated with a first phase, receive a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information.

A processor (e.g., a standalone processor chipset, or a component of a UE) for wireless communication is described. The processor may be configured to, capable of, or operable to perform one or more operations as described herein. For example, the processor may be configured to, capable of, or operable to receive a first synchronization signal associated with a first SSB, where the first synchronization signal is associated with a first phase, receive a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information.

A method performed or performable by a UE for wireless communication is described. The method may include receiving a first synchronization signal associated with a first SSB, where the first synchronization signal is associated with a first phase, receiving a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information.

In some implementations of the UE, the processor, and the method described herein, the phase rotation corresponds to a fixed phase rotation angle, and the fixed phase rotation angle maps to at least one of a value of at least one time-variant master information block (MIB) field of one or more time-variant MIB fields or a subset of bits of the one or more time-variant MIB fields. In some implementations, to determine the time-variant information, the UE, the processor, and the method may further be configured to, capable of, or operable to estimate and remove a channel based on the first synchronization signal, extract the fixed phase rotation angle based on a correlation between the first synchronization signal and the second synchronization signal, and map the fixed phase rotation angle to at least one of the value of the at least one time-variant MIB field or the subset of bits of the one or more time-variant MIB fields. In some implementations, the one or more time-variant MIB fields indicate one or more of an SSB beam index, at least a portion of a system frame number (SFN), or a half-frame indicator.

In some implementations, the first SSB and the second SSB are a same SSB. In some implementations, the first synchronization signal is a first primary synchronization signal (PSS) or a first secondary synchronization signal (SSS), and the second synchronization signal is a second PSS or a second SSS that is phase-rotated to encode the time-variant information. In some implementations, the SSB includes a set of multiple SSS symbols, at least one SSS symbol of the set of multiple SSS symbols is a reference symbol, and at least one other of the set of multiple SSS symbols is to indicate the time-variant information based on the phase rotation. In some implementations, the SSB includes a first physical broadcast channel (PBCH)-demodulation reference signal (DMRS) associated with the first phase and a second PBCH-DMRS associated with the second phase, and the second phase is phase-rotated relative to the first phase to indicate the time-variant information.

In some implementations, the first SSB and the second SSB are consecutive SSBs within a same SSB burst. In some implementations, the phase rotation is applied to at least a portion of the first synchronization signal or the second synchronization signal in a frequency domain. In some implementations, the first SSB is part of a first SSB burst and the second SSB is part of a second SSB burst. In some implementations, the first phase is common to all SSBs in the first SSB burst and the second phase is common to all SSBs in the second SSB burst. In some implementations, the first synchronization signal includes at least one of a first PSS, a first SSS, or a first PBCH-DMRS, and the second synchronization signal includes at least one of a second PSS, a second SSS, or a second PBCH-DMRS.

An NE (e.g., a base station, a gNB) for wireless communication is described. The NE may be configured to, capable of, or operable to perform one or more operations as described herein. For example, the NE may be configured to, capable of, or operable to transmit a first synchronization signal associated with a first SSB, where the first synchronization signal is associated with a first phase, transmit a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a first synchronization signal associated with a first SSB, where the first synchronization signal is associated with a first phase, transmit a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information.

A method performed or performable by an NE (e.g., a base station) for wireless communication is described. The method may include transmitting a first synchronization signal associated with a first SSB, where the first synchronization signal is associated with a first phase, transmitting a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information.

In some implementations of the NE, the processor, and the method described herein, the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. In some implementations, the NE, the processor, and the method may further be configured to, capable of, or operable to apply the phase rotation to a frequency-domain sequence of at least one of the first synchronization signal or the second synchronization signal prior to orthogonal frequency division multiplexing (OFDM) modulation. In some implementations, the one or more time-variant MIB fields indicate one or more of an SSB beam index, at least a portion of an SFN, or a half-frame indicator.

In some implementations, the first SSB and the second SSB are a same SSB. In some implementations, the first synchronization signal is a first PSS or a first SSS, and the second synchronization signal is a second PSS or a second SSS that is phase-rotated to encode the time-variant information. In some implementations, the SSB includes a set of multiple SSS symbols, at least one SSS symbol of the set of multiple SSS symbols is a reference symbol, and at least one other of the set of multiple SSS symbols is to indicate the time-variant information based on the phase rotation. In some implementations, the SSB includes a first PBCH-DMRS associated with the first phase and a second PBCH-DMRS associated with the second phase, and the second phase is phase-rotated relative to the first phase to indicate the time-variant information.

In some implementations, the first SSB and the second SSB are consecutive SSBs within a same SSB burst. In some implementations, the phase rotation is applied to at least a portion of the first synchronization signal or the second synchronization signal in a frequency domain. In some implementations, the first SSB is part of a first SSB burst and the second SSB is part of a second SSB burst. In some implementations, the first phase is common to all SSBs in the first SSB burst and the second phase is common to all SSBs in the second SSB burst. In some implementations, the first synchronization signal includes at least one of a first PSS, a first SSS, or a first PBCH-DMRS, and the second synchronization signal includes at least one of a second PSS, a second SSS, or a second PBCH DMRS.

### BRIEF DESCRIPTION OF THE DRAWINGS

FIG. 1 illustrates an example of a wireless communications system in accordance with aspects of the present disclosure.

FIG. 2 illustrates an example of an intra-SSB block structure phase rotation in accordance with aspects of the present disclosure.

FIG. 3 illustrates an example of an inter-SSB block sequence phase rotation in accordance with aspects of the present disclosure.

FIG. 4 illustrates an example of an inter-SSB burst sequence phase rotation in accordance with aspects of the present disclosure.

FIG. 5 illustrates an example of a signaling diagram in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the NE may transmit system information to one or more UEs, which may enable a UE to access the network and perform various operations such as cell selection, synchronization, and initial access. A MIB is a type of system information that carries or otherwise indicates parameters for a UE to acquire further system information and access a network. An NE may transmit an MIB via a PBCH, and the MIB may include both time-invariant information (e.g., configuration parameters that remain constant over time) and time-variant information (e.g., information that may vary over time).

In beamformed systems (e.g., wireless communications systems in which an NE transmits signals using directional beams to provide coverage in various directions), the NE may transmit the MIB across multiple beams to provide coverage in different directions, with each beam associated with an SSB. Some signals and channels may be repeatedly transmitted within a beam (e.g., PBCH, system information block (SIB) 1 (SIB1)) to improve coverage. However, such repeated transmissions within a cluster period may increase the cluster duration and reduce energy savings. Cross-beam combining of these signals and channels may be considered to improve coverage, but non-coherent combining (e.g., log-likelihood ratio (LLR) combining) of these signals and channels may be enabled while ignoring time-variant fields within the MIB. Additionally, the time-variant information may change frequently (e.g., from one SSB to another SSB, from one SSB burst to another SSB burst), requiring the UE to decode the MIB each time to obtain updated timing information, even when the time-invariant information remains unchanged. Without mechanisms to efficiently transmit time-variant information separately from the PBCH payload, the UE may experience reduced coverage, increased decoding complexity, and inefficient use of resources, particularly in scenarios in which link budgets may be constrained (e.g., scenarios involving non-terrestrial networks (NTNs) or high-frequency bands).

As described herein, to address the challenges of transmitting time-variant MIB information efficiently, a UE and an NE may support transmission of time-variant information using phase-rotated synchronization signal sequences. Specifically, the NE may transmit a first synchronization signal associated with a first SSB, where the first synchronization signal may be associated with a first phase. The NE may also transmit a second synchronization signal associated with the first SSB or a second SSB, where the second synchronization signal may be associated with a second phase that is rotated relative to the first phase. A phase rotation between the first phase and the second phase may indicate time-variant information, such as SSB beam index, part of SFN, half-frame indicator, a cluster index, and so forth. The UE and the NE may apply such phase rotation using various schemes, including intra-SSB block encoding (within the same SSB block), inter-SSB block encoding (across consecutive SSB blocks), or inter-SSB burst encoding (across entire SSB bursts). In this way, the UE may determine the time-variant information based on the phase rotation, mapping information associated with the time-variant information, or a combination thereof.

By performing the described techniques, devices (e.g., a UE and an NE) in a wireless communications system may provide for improved coverage, reduced decoding complexity, and more efficient use of resources. For example, the use of phase-rotated synchronization signals (e.g., PSS, SSS, or PBCH-DMRS) to convey time-variant information may enable the PBCH content to remain the same across all beams within an SSB burst. This may enable cross-beam PBCH combining and improve decoding reliability and extended coverage, particularly in scenarios involving constrained link budgets. Additionally, the separation of time-variant information from the PBCH payload may enable the UE to perform cell selection based on the time-invariant information without decoding the time-variant information from the PBCH, reducing decoding complexity and latency during initial access procedures. The UE may extract the phase rotation angle via complex cross-correlation between reference and encoded synchronization signals and map the phase rotation angle to the time-variant MIB field via a pre-defined look-up table. The use of different phase rotation schemes (intra-SSB block, inter-SSB block, inter-SSB burst) may enable optimization for different types of time-variant information based on their update rates, with SSB beam index encoded within or across SSB blocks and SFN or half-frame indicator encoded across SSB bursts.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

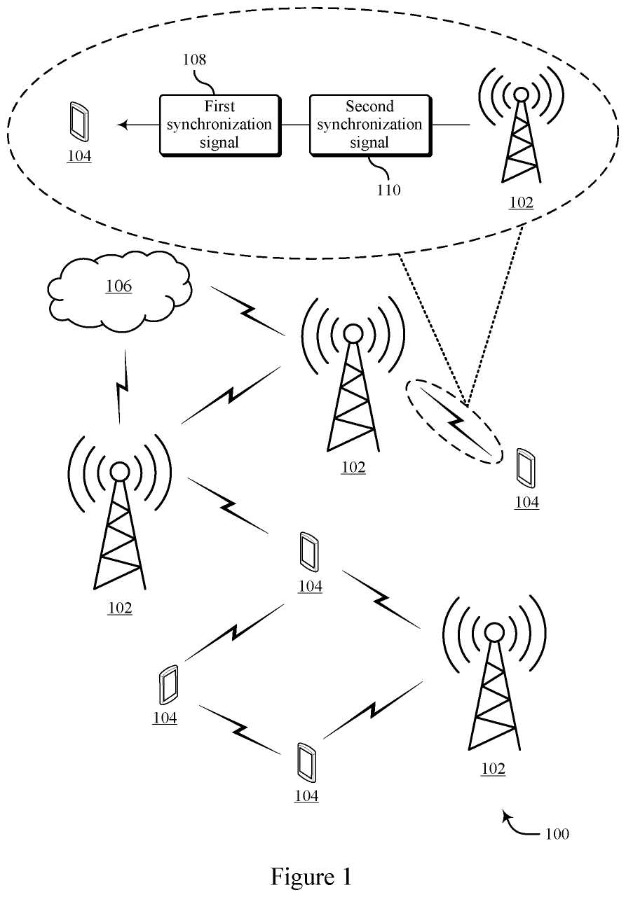

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range (FR) designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may pose various challenges. For example, emissions and energy consumption from various elements of the system may adversely contribute to the climate. Additionally, operating expenses to run the wireless communications system 100 may be large, and as such, several industry-specific factors rooted in countering rising network costs further shape efficiency efforts. A continued rise in mobile data traffic is also forecast to continue growing on a per-user basis, which combined with the rising costs of spectrum, capital investment, and ongoing RAN maintenance and upgrades, increases the desire for energy-saving measures in network operations. 5G NR may offer energy-efficiency improvements per gigabyte over previous generations of mobility. However, some 5G use cases and the adoption of millimeter-Wave (mmW) communications may require more sites and antennas. This may lead to a more efficient network that may actually result in higher emissions without active intervention.

Additionally, network energy saving, particularly in NR, is of great importance for improving environmental sustainability, reducing environmental impact (e.g., greenhouse gas emissions), and saving operational costs. As 5G is becoming more pervasive across industries and geographical areas, handling more advanced services and applications requiring very high data rates (e.g., extended reality (XR)), networks are becoming denser, using more antennas, larger bandwidths, and more frequency bands. Solutions to improve network energy savings are desired to reduce the environmental impact of 5G. Energy consumption has become a key part of the operators' operational expenses. Most of such energy consumption may come from the RAN, and in particular, from Active Antenna Units (AAUs), with data centers and fiber transport accounting for a smaller share. The power consumption of a radio access may be split into two parts: a dynamic part, which is only consumed when data transmission/reception is ongoing, and a static part, which is consumed at all times to maintain the necessary operation of the radio access devices, even when the data transmission/reception is not ongoing.

As such, there is a need to develop a network energy consumption model, key performance indicators (KPIs), and an evaluation methodology, and to identify and study network energy savings techniques in targeted deployment scenarios. For example, it may be beneficial to achieve more efficient operation dynamically and/or semi-statically and finer granularity adaptation of communications in one or more network energy saving techniques in time, frequency, spatial, and power domains, with potential support and feedback from a UE 104, UE assistance information, and information exchange and coordination over network interfaces.

Additionally, 5G NR supports a uniform distribution of channels and signals (e.g., for 20 ms), which do not require slot format adjustment. However, 6G supports clustering of common channels and signals, resulting in non-uniform transmission of 6G common channels and signals, such as SSB, SIBx, paging, random access channel (RACH), and so forth. Such clustering of channels and signals may be performed using two clustering approaches, per-beam clustering or per-burst clustering. Clustering may utilize a change in slot format to enable consecutive downlink and/or uplink slots when associated downlink common channels and signals or uplink channels are transmitted respectively. Otherwise, the clustering may result in a gap between channels and signals, further leading to gaps that may prohibit an NE 102 from entering an early sleep mode. As such, a solution to enable slot format awareness during clustering of common channels and signals is desired, which may affect network energy savings, UE performance, and user experience with respect to sync signal(s) periodicities of 20 ms and longer, at least for initial access. In some examples, such solutions may enable NE 102 support of cell-common signaling (e.g., sync signal(s), broadcast physical downlink control channel (PDCCH), SIB-1, SIB, paging, physical random access channel (PRACH)), clustered provisioning of different cell-common signaling, on-demand provisioning of different cell-common signaling, and UE-specific signaling (e.g., for low, light, medium loads), including clustered provisioning with cell-common signaling and unclustered provisioning with cell-common signaling. Impacts on a UE 104 may include cell search complexity and latency, including frequency search latency, UE power consumption, sync signal detection, coverage and tracking performance, and radio resource management (RRM), mobility, and beam management (where other properties may not be precluded). To address such UE 104 impacts, the solution may include improvements such as additional sync signal capabilities, adaptation of sync signal transmission periodicity, and sparser sync raster.

In some examples, some channels and signals may be repeatedly transmitted within a beam (e.g., PBCH, SIB1) to improve coverage. However, such repeated transmission within a cluster period may increase a cluster duration and affect energy savings. The cross-beam combining of these channels and signals may be considered however, and any time-variant field within the channels and signals may be avoided to enable non-coherent (e.g., LLR) combining of the channels and signals. However, some techniques may lack support for how and where to transmit such time-variant fields efficiently.

According to implementations, one or more of the NEs 102 and the UEs 104 are operable to implement various aspects of the techniques described with reference to the present disclosure. For example, an NE 102 may transmit a first synchronization signal 108 associated with a first SSB, where the first synchronization signal 108 may be associated with a first phase. The NE 102 may also transmit a second synchronization signal 110 associated with the first SSB or a second SSB, where the second synchronization signal 110 may be associated with a second phase that is rotated relative to the first phase. A phase rotation between the first phase and the second phase may indicate time-variant information, such as SSB beam index, part of SFN, half-frame indicator, a cluster index, and so forth. The UE 104 and the NE 102 may apply such phase rotation using various schemes, including intra-SSB block encoding (within the same SSB block), inter-SSB block encoding (across consecutive SSB blocks), or inter-SSB burst encoding (across entire SSB bursts). In this way, the UE 104 may determine the time-variant information based on the phase rotation, mapping information associated with the time-variant information, or a combination thereof.

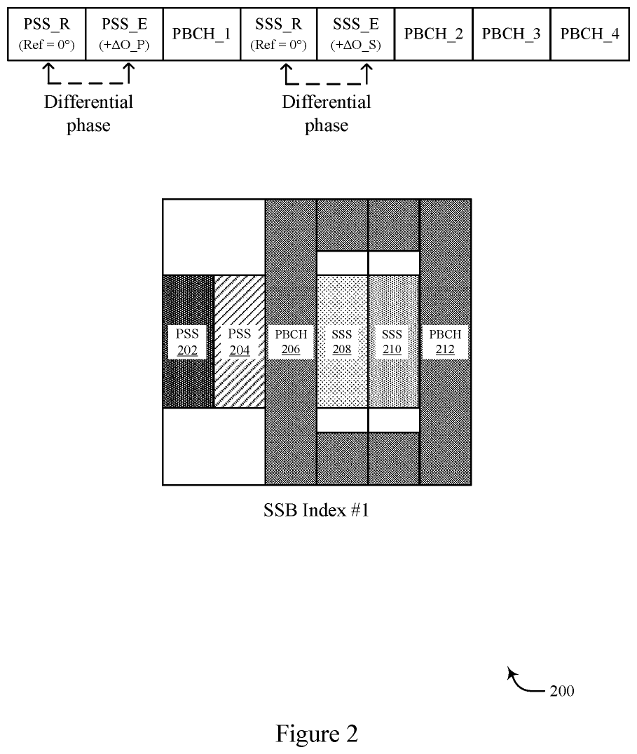

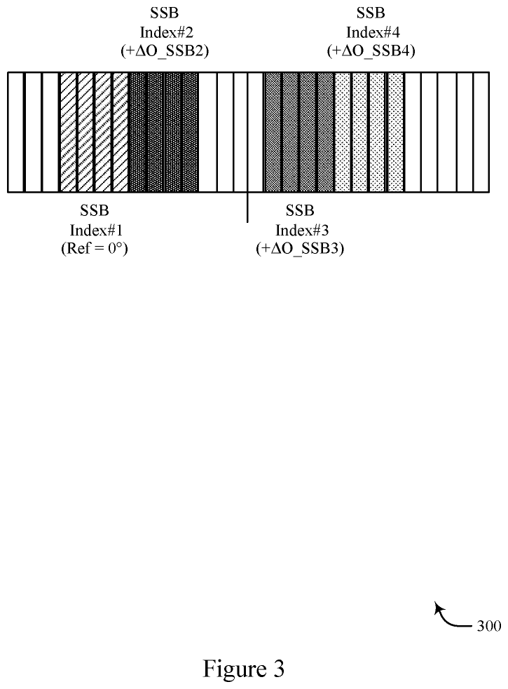

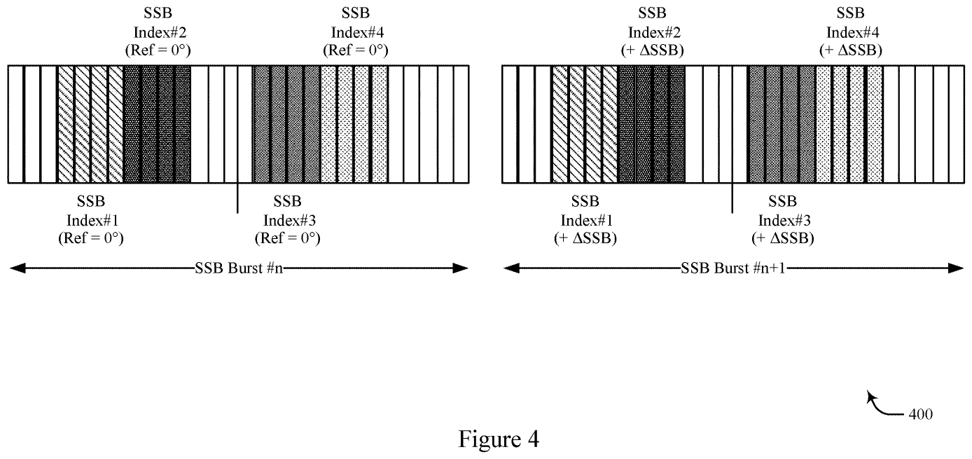

FIG. 2 illustrates an example of an intra-SSB block structure phase rotation 200 in accordance with aspects of the present disclosure. The intra-SSB block structure phase rotation 200 may implement or be implemented by aspects of the wireless communications system 100 and support a scheme for encoding time-variant information within a single SSB. As described herein with reference to FIGS. 3 and 4, aspects of the wireless communications system 100 may, additionally, or alternatively, support an inter-SSB block sequence phase rotation 300 and an inter-SSB burst sequence phase rotation 400, respectively.

A wireless communications system, including UEs and NEs, may support transmission of time-variant information using phase-rotated synchronization signal sequences. Time-variant information may include information that may change over time, such as an SSB beam index, a portion of an SFN, a cluster index, a half-frame indicator, or other related information that varies across transmissions. An NE may transmit such time-variant information using phase-rotated sequences applied to synchronization signals, including PSSs, SSSs, and PBCH-DMRSs. An NE and a UE may apply phase rotation to synchronization signals using various synchronization phase rotation schemes pertaining to SSBs. A first scheme, referred to as intra-SSB block encoding, involves encoding time-variant information within a same SSB block. A second scheme, referred to as inter-SSB block encoding, involves encoding time-variant information across consecutive SSB blocks within a same SSB burst. A third scheme, referred to as inter-SSB burst encoding, involves encoding time-variant information across entire SSB bursts (e.g., with a periodicity of 160 ms). The NE may transmit time-variant MIB fields, such as SSB beam index, a portion of SFN, half-frame indicator, and other related time-variant MIB fields, using one or more of the above schemes, or a combination thereof.

The time-variant MIB fields may be classified based on an update rate, which indicates whether the field changes within a burst, across bursts, or across SS/PBCH blocks. For example, an SSB beam index may change across SS/PBCH blocks within a burst. However, an SFN value (e.g., four least significant bits (LSBs)), cluster index, or half-frame indicator may remain the same across all transmitted SS/PBCH blocks within an SSB burst, provided the SSB burst is within a frame. The selection of a particular phase rotation scheme may be based on the update rate of the corresponding time-variant information. Table 1 includes a mapping of time-varying information to one or more modes or implementations.

TABLE 2
Mapping of time-varying information to one or more modes

| | Mapping of mode to reference signal |
|---|---|
| Information field | (implementation example) |
| SSB beam index [4:2] | Mode 1/PSS_E |
| SSB beam index [1:0] | Mode 1/SSS_E |
| SSB beam index [6:5] | Mode 1/PBCH DMRS_E or |
| | Beam group ID across SSB block using mode 2 to |
| | indicate more than 32 beams. Group ID remains |
| | same for same beam group and changes for every |
| | beam group. Within one beam group SSB beam |
| | index of up to 4 bits can be used to indicate |
| | the beams within the group. |
| Cluster index | Mode 2 |
| Part of SFN | Mode 2 and mode 3 |

An MIB may include various time-invariant and time-variant fields applicable to 5G NR, such as the fields shown in Table 2. For example, the time-invariant fields may include subCarrierSpacingCommon, ssb-SubcarrierOffset, dmrs-TypeA-Position, pdcch-ConfigSIB1, cellBarred, intraFreqReselection, and so forth. The time-variant fields may include an SFN, a half-frame indicator, an SSB index, PBCH DMRS scrambling, and so forth.

TABLE 2
Time-variant and time-invariant information for 5G NR

| | Number | |
|---|---|---|
| | of Bits | Time Variant? |
| MIB Content | | |
| systemFrameNumber | 6 bits | Yes- changes every 10 ms |
| subCarrierSpacingCommon | 1 bit | NO - static cell parameter |
| ssb-SubcarrierOffset | 4 bits | NO - static cell parameter |
| dmrs-TypeA-Position | 1 bit | NO - static cell parameter |
| pdcch-ConfigSIB1 | 8 bits | NO - quasi-static |
| cellBarred | 1 bit | NO - quasi-static |
| intraFreqReselection | 1 bit | NO - quasi-static |
| PBCH Appended Bits | | |
| (9 bits beyond MIB) | | |
| SFN | 4 bits | Yes - changes every 10 ms |
| Half-frame indicator | 1 bit | Yes - changes every 5 ms |
| SSB index | 3 bits | Yes - beam specific |
| PBCH DMRS scrambling | | Yes - SSB index, SFN, half- |
| | | frame |

In some examples, PBCH DMRS sequence initialization may depend on the UE detecting a DMRS sequence and extracting three LSBs of an SSB index. The remaining three most significant bits (MSBs) of the SSB index may be carried inside the second payload in the PBCH 212, which may include the MIB. That is, the PBCH DMRS sequence initialization may be calculated as i_{SSB}=(MSB_{3bits}<<3)+LSB_{3bits}.

In some implementations, the UE and the NE may support two methods to determine the phase rotation and the related time-variant information. A first method may involve determining a difference in phase between a first synchronization signal and a second synchronization signal associated with the first SSB or a second SSB. A second method may involve using mapping information, such as a mapping table containing a phase value mapped to a certain information element or payload, to determine the time-variant information based on the phase rotation.

In some implementations, the phase rotation may correspond to a fixed phase rotation angle. A pre-defined look-up table may map each time-variant MIB field value, or a subset of bits representing part of one or more of the time-variant MIB fields, to the fixed phase rotation angle (e.g., Δθ). For example, the phase rotation mapping may represent two bits including an LSB of an SSB beam index and an LSB of an SFN. The NE may apply the phase rotation as a scalar multiplication (e.g., e^{iΔθ}) to a frequency-domain sequence of the synchronization signal prior to OFDM modulation. The UE may use a corresponding reference symbol to estimate and remove a channel, then extract the fixed phase rotation angle (e.g., Δθ) via complex cross-correlation between the first synchronization signal and the second synchronization signal, and map the fixed phase rotation angle (e.g., Δθ) to the time-variant MIB field via the same pre-defined look-up table.

The UE and the NE may apply the phase rotation using various synchronization phase rotation schemes pertaining to SSBs. As described herein, the first scheme may include intra-SSB block encoding, where the phase rotation is applied within the same SSB block. The second scheme may include inter-SSB block encoding, where the phase rotation is applied across consecutive SSB blocks within a same SSB burst. The third scheme may include inter-SSB burst encoding, where the phase rotation is applied across entire SSB bursts (e.g., with 160 ms periodicity). The time-variant MIB fields, such as an SSB beam index, at least a portion of an SFN, a half-frame indicator, and other related time-variant MIB fields, may be transmitted using one or more of the above schemes or a combination thereof.

In the example of the intra-SSB block structure phase rotation 200, the NE 102 may encode time-variant information within a single SSB block (e.g., SS/PBCH block, SSB index #1) structure that includes a set of multiple (e.g., a plurality of) PSS symbols and a set of multiple SSS symbols along with PBCH symbols (e.g., a PBCH 206, a PBCH 212). A PSS 202 (e.g., a first PSS symbol, PSS_R) and an SSS 208 (e.g., a first SSS symbol, SSS_R) within the SSB block may serve as reference symbols associated with a first phase (e.g., a reference phase of zero degrees, Ref=0°). In addition, the NE may transmit a PSS 204 (e.g., a second PSS symbol, PSS_E) and an SSS 210 (e.g., a second SSS symbol, SSS_E) within the same SSB block with a second phase that is rotated relative to the first phase (e.g., +ΔO_P and +ΔO_S, respectively), where the phase rotation may encode time-variant information such as an SSB beam index. In such an intra-SSB block encoding scheme, the UE may decode the PSS 202 and the SSS 208 to obtain a cell identifier while extracting the phase rotation from the PSS 204 and the SSS 210 to determine the SSB beam index without requiring inter-block dependency.

According to Table 3, Symbol 0 may correspond to a reference PSS (PSS_R), which may be a standard PSS serving as a phase reference. Symbol 1 may correspond to an encoded PSS (PSS_E), which is the PSS multiplied by e^{jΔθ_P} to encode MSBs of information such as an SSB beam index. Symbol 2 may correspond to a reference SSS (SSS_R), which may be a standard SSS serving as a phase reference, and Symbol 3 may correspond to an encoded SSS (SSS_E), which may be the SSS multiplied by e^{jΔθ_S} to encode LSBs of the SSB beam index.

TABLE 3
Intra-SSB Block Encoding

| Symbol | Content | Phase | Information |
|---|---|---|---|
| 0 | PSS_R | Ref, θ = 0 | Reference for PSS_E |
| 1 | PSS_E | θ = Δθ_P(b) | Beam index MSBs 3 |
| | | | bits via 8-PSK |
| 3 | SSS_R | Ref, θ = 0 | Reference for SSS_E |
| 4 | SSS_E | θ = Δθ_S(b) | Beam index LSBs 2 |
| | | | bits via 4-PSK or 3 |
| | | | bits via 8-PSK |

In some implementations, the phase rotation encoding scheme may be adapted based on the FR and the number of beams supported by the wireless communications system. An FR refers to a designated portion of the radio frequency (RF) spectrum used for wireless communication, with different FRs supporting different numbers of beams and encoding capacities. Phase-shift keying (PSK) refers to a digital modulation technique in which the phase of a carrier signal is varied to represent data, where N-PSK (such as 4-PSK or 8-PSK) indicates that N distinct phase states may be used to encode log 2(N) bits of information.

By way of example, for an FR1 operating at approximately 3.5 GHz and supporting 8 beams, the PSS may use 8-PSK modulation to encode 3 bits, which directly encodes the beam index ranging from 0 to 7. The SSS may also use 8-PSK modulation to encode 3 bits, representing a combination of a half-frame indicator and SFN occasion bits, such as the within-burst SFN LSBs combined with the half-frame indicator (e.g., {half-frame[0], SFN_occasion[1:0]}, within-burst SFN LSBs+half-frame indicator). This configuration provides a total of 6 bits of time-variant information per SSB block.

By way of another example, for an FR3 operating at approximately 7 GHz and supporting 32 beams, the PSS may use 8-PSK modulation to encode 3 bits representing the beam MSBs, calculated as the floor of the beam index divided by 4 (e.g., floor(b/4)). The SSS may use 4-PSK modulation to encode 2 bits representing the beam LSBs, calculated as the beam index modulo 4 (e.g., b mod 4). This configuration provides a total of 5 bits per SSB block, which is sufficient to encode the complete beam index. In this scenario, no remaining SSS capacity (e.g., 0 bits) is available for other fields (e.g., the SSS capacity is fully used), and the SFN and half-frame indicator may be separately encoded using inter-SSB burst encoding across SSB bursts.

By way of another example, for an FR2 operating at approximately 28 GHz and supporting 64 beams, the PSS may use 8-PSK modulation to encode 3 bits representing the beam MSBs, calculated as the floor of the beam index divided by 8 (e.g., floor(b/8). The SSS may also use 8-PSK modulation to encode 3 bits representing the beam LSBs, calculated as the beam index modulo 8 (e.g., b mod 4). This configuration provides a total of 6 bits per SSB block, which is sufficient to encode the complete beam index. In this scenario, no capacity (e.g., 0 bits) remains for other fields within the SSB block, and the SFN and half-frame indicator may be encoded using inter-SSB burst encoding.

In some implementations, when an SSB block includes a number (e.g., X) of SSS symbols transmitted consecutively or non-consecutively, one or more of the SSS symbols may serve as reference symbols, and the NE may use the remaining SSS symbols to convey time-variant information using the phase rotation relative to the reference symbols. Additionally, or alternatively, when the NE transmits the PBCH repeatedly within an SSB block, a second repetition of the PBCH-DMRS may be phase-rotated relative to a first PBCH-DMRS that serves as a reference, enabling the phase rotation to convey time-variant information. In some implementations, the NE may apply the phase rotation to a portion of one or more instances of the PSS, the SSS, or the PBCH-DMRS in the frequency domain. For example, the phase rotation may be applied to a lower half of two consecutive PSSs in the frequency domain.

FIG. 3 illustrates an example of an inter-SSB block sequence phase rotation 300 in accordance with aspects of the present disclosure. The inter-SSB block sequence phase rotation 300 may implement or be implemented by aspects of the wireless communications system 100. In this example, the inter-SSB block sequence phase rotation 300 depicts encoding of time-variant information across consecutive SSB blocks within a same SSB burst. In the inter-SSB block sequence phase rotation 300, a first phase may be associated with a first SSB and a second phase may be associated with a second SSB, where the second phase may be rotated relative to the first phase to indicate time-variant information such as SSB beam index, cluster index, or an LSB portion of an SFN.

In the example of FIG. 3, the inter-SSB block sequence phase rotation 300 includes multiple SSB indices within an SSB burst, including SSB Index #1, SSB Index #2, SSB Index #3, and SSB Index #4. SSB Index #1 may serve as a reference with a phase of zero degrees (e.g., Ref=0°). SSB Index #2 may be associated with a phase offset (e.g., +ΔO_SSB2), SSB Index #3 may be associated with a phase offset (e.g., +ΔO_SSB3), and SSB Index #4 may be associated with a phase offset (e.g., +ΔO_SSB4). The phases of each SSB block may be mapped to an information element in a predefined table to convey the time-variant information.

In some implementations, even-indexed SSB blocks may serve as reference blocks with a phase of zero degrees (e.g., Ref=0°), while odd-indexed SSB blocks may carry an encoded phase rotation (e.g., θ=Δθ_cluster). The UE may correlate across adjacent SSB blocks to extract the phase rotation and determine the time-variant information. For example, with 16 reference-encoded pairs per 32-beam burst, the UE may perform cross-correlation between consecutive SSB blocks to detect the phase rotation angle. In some implementations, the NE may apply the phase rotation to a PSS, an SSS, or a PBCH-DMRS within each SSB block. In some other implementations, the NE may apply the phase rotation to a portion of one or multiple instances of PSS, SSS, or PBCH-DMRS in the frequency domain. For example, the NE may apply the phase rotation to a bottom half of two consecutive PSSs in the frequency domain.

FIG. 4 illustrates an example of an inter-SSB burst sequence phase rotation 400 in accordance with aspects of the present disclosure. The inter-SSB burst sequence phase rotation 400 may implement or be implemented by aspects of the wireless communications system 100. The inter-SSB burst sequence phase rotation 400 illustrates a phase rotation scheme applied across entire SSB bursts to encode time-variant information.

In the example of FIG. 4, the inter-SSB burst sequence phase rotation 400 includes two consecutive SSB bursts, SSB Burst #n and SSB Burst #n+1. Within SSB Burst #n, four SSB blocks, SSB Index #1, SSB Index #2, SSB Index #3, and SSB Index #4, may each be associated with a first phase that serves as a reference phase (e.g., Ref=0°). Within SSB Burst #n+1, four corresponding SSB blocks, SSB Index #1, SSB Index #2, SSB Index #3, and SSB Index #4, may each be associated with a second phase that includes a phase rotation (e.g., +ΔSSB) relative to the first phase. The first phase may be common to all SSBs in the first SSB burst and the second phase may be common to all SSBs in the second SSB burst.

In the inter-SSB burst sequence phase rotation 400, the NE may apply a uniform phase rotation to each beam in a burst. The UE may combine observations across all detected beams to estimate the burst-level phase. The phase rotation between the first phase and the second phase may indicate time-variant information, such as part of an SFN or a half-frame indicator. SFN bits may be progressively encoded in successive bursts at rates matched to their update frequency. A pre-defined schedule may define which SFN bit group is encoded in each burst occasion. In one example, every fourth SSB burst may be phase shifted to indicate the part of SFN.

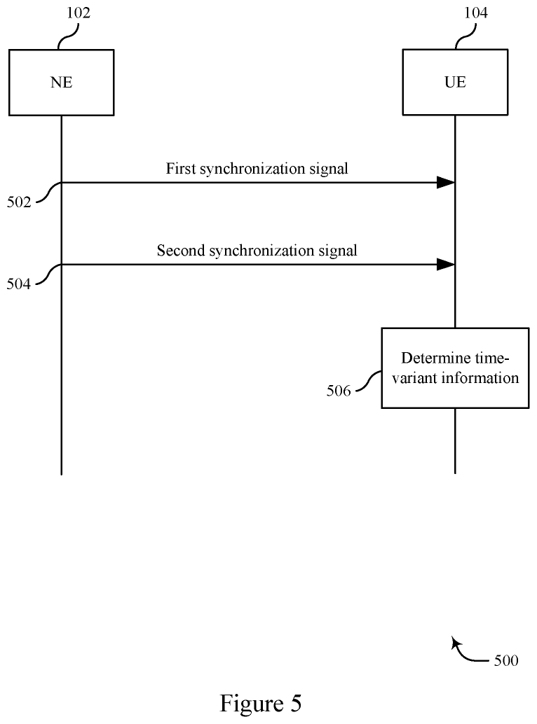

FIG. 5 illustrates an example of a signaling diagram 500 in accordance with aspects of the present disclosure. In some examples, the signaling diagram 500 implements or is implemented by aspects of the wireless communications system 100, the intra-SSB block structure phase rotation 200, the inter-SSB block sequence phase rotation 300, and the inter-SSB burst sequence phase rotation 400. The signaling diagram 500 may implement or be implemented by NE 102 and UE 104, which may be examples of the corresponding devices as described with reference to FIGS. 1 through 4. For example, the NE 102 may transmit synchronization signals with phase rotation to indicate time-variant information to the UE 104. Alternative examples of the following may be implemented, where some processes are performed in a different order than described or are not performed. In some cases, processes may include additional features not mentioned below, or further processes may be added.

At 502, the NE 102 may transmit a first synchronization signal to the UE 104. The first synchronization signal may be associated with a first SSB, and the first synchronization signal may be associated with a first phase. The first synchronization signal may include at least one of a first PSS, a first SSS, or a first PBCH-DMRS. In some implementations, the first synchronization signal may serve as a reference signal for subsequent phase rotation detection. In some implementations, the first phase may be common to all SSBs in a first SSB burst.

At 504, the NE 102 may transmit a second synchronization signal to the UE 104. The second synchronization signal may be associated with the first SSB or a second SSB, and the second synchronization signal may be associated with a second phase that is rotated relative to the first phase. The second synchronization signal may include at least one of a second PSS, a second SSS, or a second PBCH-DMRS. A phase rotation between the first phase and the second phase may indicate time-variant information. In some implementations, the first SSB and the second SSB may be a same SSB, and the second synchronization signal may be a second PSS or a second SSS that is phase-rotated to encode the time-variant information.

In some implementations, the SSB may include a set of multiple SSS symbols, where at least one SSS symbol of the set of multiple SSS symbols may be a reference symbol, and at least one other of the set of multiple SSS symbols may indicate the time-variant information based on the phase rotation. In some implementations, the SSB may include a first PBCH-DMRS associated with the first phase and a second PBCH-DMRS associated with the second phase, and the second phase may be phase-rotated relative to the first phase to indicate the time-variant information. In some implementations, the first SSB and the second SSB may be consecutive SSBs within a same SSB burst, and the phase rotation may be applied to at least a portion of the first synchronization signal or the second synchronization signal in a frequency domain. In some implementations, the first SSB may be part of a first SSB burst and the second SSB may be part of a second SSB burst, and the first phase may be common to all SSBs in the first SSB burst and the second phase may be common to all SSBs in the second SSB burst.

At 506, the UE 104 may communicate in accordance with time-variant information, where the time-variant information is based on one or more of a phase rotation calculated using the first phase and the second phase or mapping information associated with the time-variant information. The phase rotation may correspond to a fixed phase rotation angle, and the fixed phase rotation angle may map to at least one of a value of at least one time-variant MIB field of one or more time-variant MIB fields or a subset of bits of the one or more time-variant MIB fields. The one or more time-variant MIB fields may indicate one or more of an SSB beam index, at least a portion of an SFN, or a half-frame indicator. In some implementations, to determine the time-variant information, the UE 104 may estimate and remove a channel based on the first synchronization signal, extract the fixed phase rotation angle based on a correlation between the first synchronization signal and the second synchronization signal, and map the fixed phase rotation angle to at least one of the value of the at least one time-variant MIB field or the subset of bits of the one or more time-variant MIB fields. The UE 104 may extract the phase rotation angle via complex cross-correlation between the first synchronization signal and the second synchronization signal and map the phase rotation angle to the time-variant information using a pre-defined look-up table.

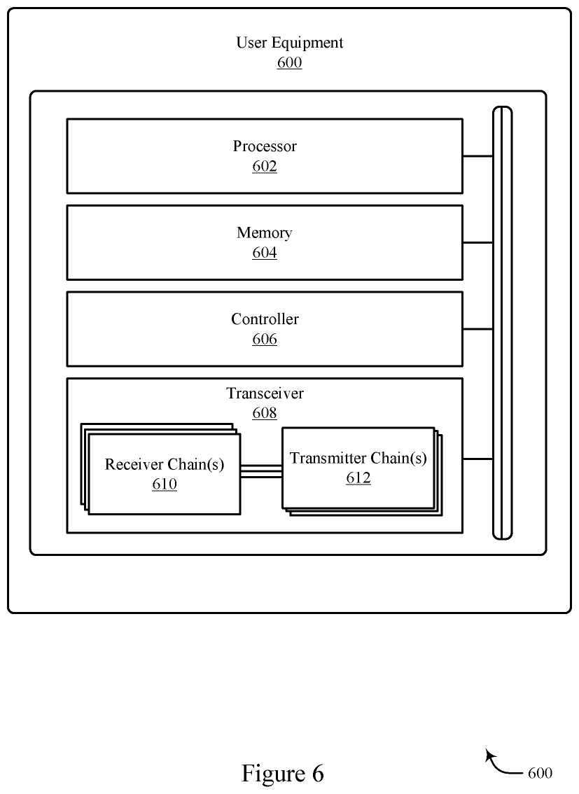

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving a first synchronization signal associated with a first SSB, where the first synchronization signal is associated with a first phase, receiving a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information. In this manner, the UE 600 supports improved coverage and reduced decoding complexity by enabling cross-beam PBCH combining and efficient extraction of time-variant information without requiring full PBCH decoding for each SSB.

Additionally, the UE 600 may be configured to support any one or combination of the following. For example, the UE 600 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the UE 600. Additionally, or alternatively, the UE 600 may be configured to or operable to support, to determine the time-variant information, estimating and removing a channel based on the first synchronization signal, extracting the fixed phase rotation angle based on a correlation between the first synchronization signal and the second synchronization signal, and mapping the fixed phase rotation angle to at least one of the value of the at least one time-variant MIB field or the subset of bits of the one or more time-variant MIB fields. This aspect contributes to the improved coverage and reduced decoding complexity by leveraging channel estimation and cross-correlation techniques, enhancing decoding performance particularly in constrained link budget scenarios at the UE 600. Additionally, or alternatively, the UE 600 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the UE 600.

Additionally, or alternatively, the UE 600 may be configured to or operable to support where the first SSB and the second SSB are a same SSB. This aspect contributes to the improved coverage and reduced decoding complexity by enabling intra-SSB block encoding of time-variant information, allowing the UE 600 to extract timing information from a single SSB without requiring reception of multiple SSBs. Additionally, or alternatively, the UE 600 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the UE 600. Additionally, or alternatively, the UE 600 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information extraction using multiple SSS symbols with differential phase encoding at the UE 600. Additionally, or alternatively, the UE 600 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the UE 600.

Additionally, or alternatively, the UE 600 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the UE 600. Additionally, or alternatively, the UE 600 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information extraction at the UE 600. Additionally, or alternatively, the UE 600 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the UE 600. Additionally, or alternatively, the UE 600 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the UE 600. Additionally, or alternatively, the UE 600 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the UE 600.

Additionally, or alternatively, the UE 600 may support at least one memory (e.g., the memory 604) and at least one processor (e.g., the processor 602) coupled with the at least one memory and configured to cause the UE to receive a first synchronization signal associated with a first SSB, where the first synchronization signal is associated with a first phase, receive a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information. In this manner, the UE 600 supports improved coverage and reduced decoding complexity by enabling cross-beam PBCH combining and efficient extraction of time-variant information without requiring full PBCH decoding for each SSB.

Additionally, the UE 600 may be configured to support any one or combination of the following. For example, the UE 600 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the UE 600. Additionally, or alternatively, the UE 600 may be configured to or operable to support, to determine the time-variant information, estimating and removing a channel based on the first synchronization signal, extracting the fixed phase rotation angle based on a correlation between the first synchronization signal and the second synchronization signal, and mapping the fixed phase rotation angle to at least one of the value of the at least one time-variant MIB field or the subset of bits of the one or more time-variant MIB fields. This aspect contributes to the improved coverage and reduced decoding complexity by leveraging channel estimation and cross-correlation techniques, enhancing decoding performance particularly in constrained link budget scenarios at the UE 600. Additionally, or alternatively, the UE 600 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the UE 600.

Additionally, or alternatively, the UE 600 may be configured to or operable to support where the first SSB and the second SSB are a same SSB. This aspect contributes to the improved coverage and reduced decoding complexity by enabling intra-SSB block encoding of time-variant information, allowing the UE 600 to extract timing information from a single SSB without requiring reception of multiple SSBs. Additionally, or alternatively, the UE 600 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the UE 600. Additionally, or alternatively, the UE 600 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information extraction using multiple SSS symbols with differential phase encoding at the UE 600. Additionally, or alternatively, the UE 600 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the UE 600.

Additionally, or alternatively, the UE 600 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the UE 600. Additionally, or alternatively, the UE 600 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information extraction at the UE 600. Additionally, or alternatively, the UE 600 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the UE 600. Additionally, or alternatively, the UE 600 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the UE 600. Additionally, or alternatively, the UE 600 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the UE 600.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

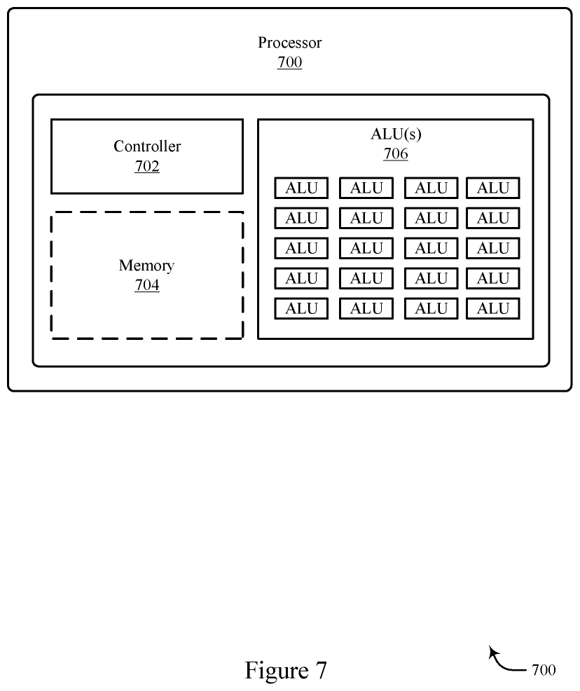

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive a first synchronization signal associated with a first SSB, where the first synchronization signal is associated with a first phase, receive a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information. In this manner, the processor 700 supports improved coverage and reduced decoding complexity by enabling cross-beam PBCH combining and efficient extraction of time-variant information without requiring full PBCH decoding for each SSB.

Additionally, the processor 700 may be configured to support any one or combination of the following. For example, the processor 700 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the processor 700. Additionally, or alternatively, the processor 700 may be configured to or operable to support, to determine the time-variant information, estimating and removing a channel based on the first synchronization signal, extracting the fixed phase rotation angle based on a correlation between the first synchronization signal and the second synchronization signal, and mapping the fixed phase rotation angle to at least one of the value of the at least one time-variant MIB field or the subset of bits of the one or more time-variant MIB fields. This aspect contributes to the improved coverage and reduced decoding complexity by leveraging channel estimation and cross-correlation techniques, enhancing decoding performance particularly in constrained link budget scenarios at the processor 700. Additionally, or alternatively, the processor 700 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the processor 700.

Additionally, or alternatively, the processor 700 may be configured to or operable to support where the first SSB and the second SSB are a same SSB. This aspect contributes to the improved coverage and reduced decoding complexity by enabling intra-SSB block encoding of time-variant information, allowing the processor 700 to extract timing information from a single SSB without requiring reception of multiple SSBs. Additionally, or alternatively, the processor 700 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the processor 700. Additionally, or alternatively, the processor 700 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information extraction using multiple SSS symbols with differential phase encoding at the processor 700. Additionally, or alternatively, the processor 700 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the processor 700.

Additionally, or alternatively, the processor 700 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the processor 700. Additionally, or alternatively, the processor 700 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information extraction at the processor 700. Additionally, or alternatively, the processor 700 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the processor 700. Additionally, or alternatively, the processor 700 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the processor 700. Additionally, or alternatively, the processor 700 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the processor 700.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit a first synchronization signal associated with a first SSB, where the first synchronization signal is associated with a first phase, transmit a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information. In this manner, the processor 700 supports improved coverage and reduced decoding complexity by enabling cross-beam PBCH combining and efficient transmission of time-variant information without requiring changes to the PBCH payload for each SSB.

Additionally, the processor 700 may be configured to support any one or combination of the following. For example, the processor 700 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the receiving UE. Additionally, or alternatively, the processor 700 may be configured to or operable to support applying the phase rotation to a frequency-domain sequence of at least one of the first synchronization signal or the second synchronization signal prior to OFDM modulation. This aspect contributes to the improved coverage and reduced decoding complexity by enabling efficient frequency-domain phase rotation application, reducing processing complexity and improving signal quality for time-variant information transmission at the processor 700. Additionally, or alternatively, the processor 700 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the receiving UE.

Additionally, or alternatively, the processor 700 may be configured to or operable to support where the first SSB and the second SSB are a same SSB. This aspect contributes to the improved coverage and reduced decoding complexity by enabling intra-SSB block encoding of time-variant information, allowing the receiving UE to extract timing information from a single SSB without requiring reception of multiple SSBs. Additionally, or alternatively, the processor 700 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the processor 700. Additionally, or alternatively, the processor 700 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information transmission using multiple SSS symbols with differential phase encoding at the processor 700. Additionally, or alternatively, the processor 700 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the processor 700.

Additionally, or alternatively, the processor 700 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the processor 700. Additionally, or alternatively, the processor 700 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information transmission at the processor 700. Additionally, or alternatively, the processor 700 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the processor 700. Additionally, or alternatively, the processor 700 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the receiving UE. Additionally, or alternatively, the processor 700 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the processor 700.

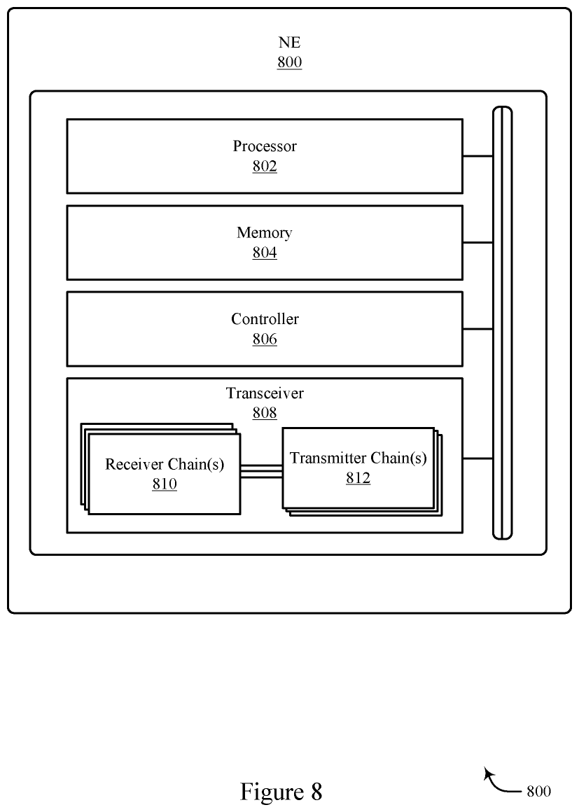

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a first synchronization signal associated with a first SSB, where the first synchronization signal is associated with a first phase, transmitting a second synchronization signal associated with the first SSB or a second SSB, where the second synchronization signal is associated with a second phase that is rotated relative to the first phase, and communicating in accordance with time-variant information, where the time-variant information is based on one or more of a phase rotation calculated using the first phase and the second phase or mapping information associated with the time-variant information. In this manner, the NE 800 supports improved coverage and reduced decoding complexity by enabling cross-beam PBCH combining and efficient transmission of time-variant information without requiring changes to the PBCH payload for each SSB.

Additionally, the NE 800 may be configured to or operable to support any one or combination of the following. For example, the NE 800 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the receiving UE. Additionally, or alternatively, the NE 800 may be configured to or operable to support applying the phase rotation to a frequency-domain sequence of at least one of the first synchronization signal or the second synchronization signal prior to OFDM modulation. This aspect contributes to the improved coverage and reduced decoding complexity by enabling efficient frequency-domain phase rotation application, reducing processing complexity and improving signal quality for time-variant information transmission at the NE 800. Additionally, or alternatively, the NE 800 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the receiving UE.

Additionally, or alternatively, the NE 800 may be configured to or operable to support where the first SSB and the second SSB are a same SSB. This aspect contributes to the improved coverage and reduced decoding complexity by enabling intra-SSB block encoding of time-variant information, allowing the receiving UE to extract timing information from a single SSB without requiring reception of multiple SSBs. Additionally, or alternatively, the NE 800 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the NE 800. Additionally, or alternatively, the NE 800 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information transmission using multiple SSS symbols with differential phase encoding at the NE 800. Additionally, or alternatively, the NE 800 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the NE 800.

Additionally, or alternatively, the NE 800 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the NE 800. Additionally, or alternatively, the NE 800 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information transmission at the NE 800. Additionally, or alternatively, the NE 800 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the NE 800. Additionally, or alternatively, the NE 800 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the receiving UE. Additionally, or alternatively, the NE 800 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the NE 800.

Additionally, or alternatively, the NE 800 may support at least one memory (e.g., the memory 804) and at least one processor (e.g., the processor 802) coupled with the at least one memory and configured to cause the NE to transmit a first synchronization signal associated with a first SSB, where the first synchronization signal is associated with a first phase, transmit a second synchronization signal associated with the first SSB or a second SSB, where the second synchronization signal is associated with a second phase that is rotated relative to the first phase, and communicate in accordance with time-variant information, where the time-variant information is based on one or more of a phase rotation calculated using the first phase and the second phase or mapping information associated with the time-variant information. In this manner, the NE 800 supports improved coverage and reduced decoding complexity by enabling cross-beam PBCH combining and efficient transmission of time-variant information without requiring changes to the PBCH payload for each SSB.

Additionally, the NE 800 may be configured to support any one or combination of the following. For example, the NE 800 may be configured to or operable to support where the phase rotation corresponds to a fixed phase rotation angle, and the fixed phase rotation angle maps to at least one of a value of at least one time-variant MIB field of one or more time-variant MIB fields or a subset of bits of the one or more time-variant MIB fields. This aspect contributes to the improved coverage and reduced decoding complexity by enabling efficient mapping of phase rotation angles to time-variant information using pre-defined look-up tables, reducing computational complexity and improving decoding reliability at the receiving UE. Additionally, or alternatively, the NE 800 may be configured to or operable to support applying the phase rotation to a frequency-domain sequence of at least one of the first synchronization signal or the second synchronization signal prior to OFDM modulation. This aspect contributes to the improved coverage and reduced decoding complexity by enabling efficient frequency-domain phase rotation application, reducing processing complexity and improving signal quality for time-variant information transmission at the NE 800. Additionally, or alternatively, the NE 800 may be configured to or operable to support where the one or more time-variant MIB fields indicate one or more of an SSB beam index, at least a portion of an SFN, or a half-frame indicator. This aspect contributes to the improved coverage and reduced decoding complexity by enabling efficient transmission of frequently changing timing information separately from the PBCH payload, reducing latency during initial access procedures and supporting faster cell selection at the receiving UE.

Additionally, or alternatively, the NE 800 may be configured to or operable to support where the first SSB and the second SSB are a same SSB. This aspect contributes to the improved coverage and reduced decoding complexity by enabling intra-SSB block encoding of time-variant information, allowing the receiving UE to extract timing information from a single SSB without requiring reception of multiple SSBs. Additionally, or alternatively, the NE 800 may be configured to or operable to support where the first synchronization signal is a first PSS or a first SSS, and the second synchronization signal is a second PSS or a second SSS that is phase-rotated to encode the time-variant information. This aspect contributes to the improved coverage and reduced decoding complexity by leveraging existing synchronization signal structures for time-variant information encoding, improving spectral efficiency and maintaining backward compatibility at the NE 800. Additionally, or alternatively, the NE 800 may be configured to or operable to support where the SSB includes a set of multiple SSS symbols, at least one SSS symbol of the set of multiple SSS symbols is a reference symbol, and at least one other of the set of multiple SSS symbols is to indicate the time-variant information based on the phase rotation. This aspect contributes to the improved coverage and reduced decoding complexity by providing enhanced reliability for time-variant information transmission using multiple SSS symbols with differential phase encoding at the NE 800. Additionally, or alternatively, the NE 800 may be configured to or operable to support where the SSB includes a first PBCH-DMRS associated with the first phase and a second PBCH-DMRS associated with the second phase, and the second phase is phase-rotated relative to the first phase to indicate the time-variant information. This aspect contributes to the improved coverage and reduced decoding complexity by enabling time-variant information encoding using PBCH-DMRS signals, providing an alternative encoding mechanism that leverages existing reference signal structures for improved coverage at the NE 800.

Additionally, or alternatively, the NE 800 may be configured to or operable to support where the first SSB and the second SSB are consecutive SSBs within a same SSB burst. This aspect contributes to the improved coverage and reduced decoding complexity by enabling inter-SSB block encoding of time-variant information such as SSB beam index, allowing efficient beam identification across consecutive SSBs within a burst at the NE 800. Additionally, or alternatively, the NE 800 may be configured to or operable to support where the phase rotation is applied to at least a portion of the first synchronization signal or the second synchronization signal in a frequency domain. This aspect contributes to the improved coverage and reduced decoding complexity by enabling efficient frequency-domain phase rotation application, reducing processing complexity and improving signal quality for time-variant information transmission at the NE 800. Additionally, or alternatively, the NE 800 may be configured to or operable to support where the first SSB is part of a first SSB burst and the second SSB is part of a second SSB burst. This aspect contributes to the improved coverage and reduced decoding complexity by enabling inter-SSB burst encoding of time-variant information such as SFN or half-frame indicator, supporting efficient transmission of information that changes across SSB bursts at the NE 800. Additionally, or alternatively, the NE 800 may be configured to or operable to support where the first phase is common to all SSBs in the first SSB burst and the second phase is common to all SSBs in the second SSB burst. This aspect contributes to the improved coverage and reduced decoding complexity by enabling cross-beam PBCH combining within each SSB burst by maintaining uniform phase across all beams, improving decoding reliability and extended coverage in constrained link budget scenarios at the receiving UE. Additionally, or alternatively, the NE 800 may be configured to or operable to support where the first synchronization signal includes at least one of a first PSS, a first SSS, or a first PBCH-DMRS, and the second synchronization signal includes at least one of a second PSS, a second SSS, or a second PBCH-DMRS. This aspect contributes to the improved coverage and reduced decoding complexity by providing flexibility in selecting synchronization signal types for phase rotation encoding, enabling optimization based on channel conditions and system requirements at the NE 800.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

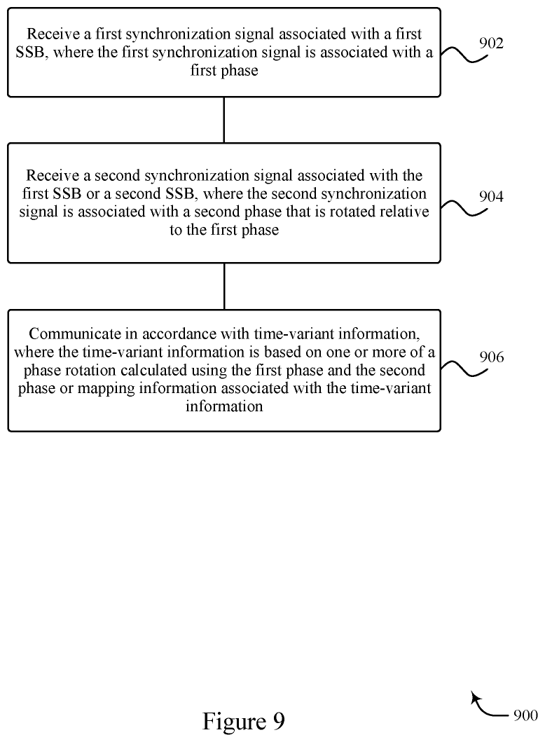

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving a first synchronization signal associated with a first SSB, where the first synchronization signal is associated with a first phase. The operations of 902 may be performed in accordance with examples as described herein. In some implementations, aspects of the operations of 902 may be performed by a UE as described with reference to FIG. 6.

At 904, the method may include receiving a second synchronization signal associated with the first SSB or a second SSB, where the second synchronization signal is associated with a second phase that is rotated relative to the first phase. The operations of 904 may be performed in accordance with examples as described herein. In some implementations, aspects of the operations of 904 may be performed by a UE as described with reference to FIG. 6.

At 906, the method may include communicating in accordance with time-variant information, where the time-variant information is based on one or more of a phase rotation calculated using the first phase and the second phase or mapping information associated with the time-variant information. The operations of 906 may be performed in accordance with examples as described herein. In some implementations, aspects of the operations of 906 may be performed a UE as described with reference to FIG. 6.

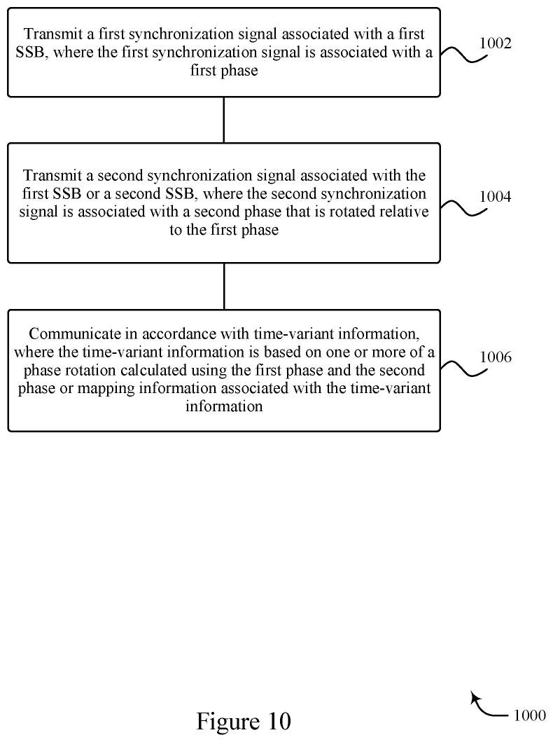

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting a first synchronization signal associated with a first SSB, where the first synchronization signal is associated with a first phase. The operations of 1002 may be performed in accordance with examples as described herein. In some implementations, aspects of the operations of 1002 may be performed by an NE as described with reference to FIG. 8.

At 1004, the method may include transmitting a second synchronization signal associated with the first SSB or a second SSB, where the second synchronization signal is associated with a second phase that is rotated relative to the first phase. The operations of 1004 may be performed in accordance with examples as described herein. In some implementations, aspects of the operations of 1004 may be performed by an NE as described with reference to FIG. 8.

At 1006, the method may include communicating in accordance with time-variant information, where the time-variant information is based on one or more of a phase rotation calculated using the first phase and the second phase or mapping information associated with the time-variant information. The operations of 1006 may be performed in accordance with examples as described herein. In some implementations, aspects of the operations of 1006 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a first synchronization signal associated with a first synchronization signal block (SSB), wherein the first synchronization signal is associated with a first phase;
receive a second synchronization signal associated with the first SSB or a second SSB, wherein the second synchronization signal is associated with a second phase that is rotated relative to the first phase; and
communicate in accordance with time-variant information, wherein the time-variant information is based at least in part on one or more of a phase rotation calculated using the first phase and the second phase or mapping information associated with the time-variant information.

2. The UE of claim 1, wherein the phase rotation corresponds to a fixed phase rotation angle, and wherein the fixed phase rotation angle maps to at least one of a value of at least one time-variant master information block (MIB) field of one or more time-variant MIB fields or a subset of bits of the one or more time-variant MIB fields.

3. The UE of claim 2, wherein, to determine the time-variant information, the at least one processor is further operable to cause the UE to:
estimate and remove a channel based at least in part on the first synchronization signal;
extract the fixed phase rotation angle based at least in part on a correlation between the first synchronization signal and the second synchronization signal; and
map the fixed phase rotation angle to at least one of the value of the at least one time-variant MIB field or the subset of bits of the one or more time-variant MIB fields.

4. The UE of claim 2, wherein the one or more time-variant MIB fields indicate one or more of an SSB beam index, at least a portion of a system frame number (SFN), or a half-frame indicator.

5. The UE of claim 1, wherein the first SSB and the second SSB are a same SSB.

6. The UE of claim 5, wherein the first synchronization signal is a first primary synchronization signal (PSS) or a first secondary synchronization signal (SSS), and wherein the second synchronization signal is a second PSS or a second SSS that is phase-rotated to encode the time-variant information.

7. The UE of claim 5, wherein the SSB comprises a plurality of secondary synchronization signal (SSS) symbols, wherein at least one SSS symbol of the plurality of SSS symbols is a reference symbol, and wherein at least one other of the plurality of SSS symbols is indicate the time-variant information based at least in part on the phase rotation.

8. The UE of claim 5, wherein the SSB comprises a first physical broadcast channel (PBCH)-demodulation reference signal (DMRS) associated with the first phase and a second PBCH-DMRS associated with the second phase, and wherein the second phase is phase-rotated relative to the first phase to indicate the time-variant information.

9. The UE of claim 1, wherein the first SSB and the second SSB are consecutive SSBs within a same SSB burst, and wherein the phase rotation is applied to at least a portion of the first synchronization signal or the second synchronization signal in a frequency domain.

10. The UE of claim 1, wherein the first SSB is part of a first SSB burst and the second SSB is part of a second SSB burst, and wherein the first phase is common to all SSBs in the first SSB burst and the second phase is common to all SSBs in the second SSB burst.

11. The UE of claim 1, wherein the first synchronization signal comprises at least one of a first primary synchronization signal (PSS), a first secondary synchronization signal (SSS), or a first physical broadcast channel (PBCH)-demodulation reference signal (DMRS), wherein the second synchronization signal comprises at least one of a second PSS, a second SSS, or a second PBCH DMRS.

12. A network equipment (NE) for wireless communication, comprising:
at least one memory; and
at least one processor coupled with the at least one memory and operable to cause the NE to:
transmitting a first synchronization signal associated with a first synchronization signal block (SSB), wherein the first synchronization signal is associated with a first phase;
transmitting a second synchronization signal associated with the first SSB or a second SSB, wherein the second synchronization signal is associated with a second phase that is rotated relative to the first phase; and
communicating in accordance with time-variant information, wherein the time-variant information is based at least in part on one or more of a phase rotation calculated using the first phase and the second phase or mapping information associated with the time-variant information.

13. The NE of claim 12, wherein the phase rotation corresponds to a fixed phase rotation angle, and wherein the fixed phase rotation angle maps to at least one of a value of at least one time-variant master information block (MIB) field of one or more time-variant MIB fields or a subset of bits of the one or more time-variant MIB fields.

14. The NE of claim 13, wherein the at least one processor is operable to cause the NE to: apply the phase rotation is applied to a frequency-domain sequence of at least one of the first synchronization signal or the second synchronization signal prior to orthogonal frequency division multiplexing (OFDM) modulation.

15. The NE of claim 13, wherein the one or more time-variant MIB fields indicate one or more of an SSB beam index, at least a portion of a system frame number (SFN), or a half-frame indicator.

16. The NE of claim 12, wherein the first SSB and the second SSB are a same SSB.

17. The NE of claim 16, wherein the first synchronization signal is a first primary synchronization signal (PSS) or a first secondary synchronization signal (SSS), and wherein the second synchronization signal is a second PSS or a second SSS that is phase-rotated to encode the time-variant information.

18. The NE of claim 12, wherein the first SSB and the second SSB are consecutive SSBs within a same SSB burst.

19. A method performed by a user equipment (UE), the method comprising:
receiving a first synchronization signal associated with a first synchronization signal block (SSB), wherein the first synchronization signal is associated with a first phase;
receiving a second synchronization signal associated with the first SSB or a second SSB, wherein the second synchronization signal is associated with a second phase that is rotated relative to the first phase; and
communicating in accordance with time-variant information, wherein the time-variant information is based at least in part on one or more of a phase rotation calculated using the first phase and the second phase or mapping information associated with the time-variant information.

20. A method performed by a network equipment (NE), the method comprising:
transmitting a first synchronization signal associated with a first synchronization signal block (SSB), wherein the first synchronization signal is associated with a first phase;
transmitting a second synchronization signal associated with the first SSB or a second SSB, wherein the second synchronization signal is associated with a second phase that is rotated relative to the first phase; and
communicating in accordance with time-variant information, wherein the time-variant information is based at least in part on one or more of a phase rotation calculated using the first phase and the second phase or mapping information associated with the time-variant information.
